(19) United States
(12) Patent Application Publication
(10) Pub. No.: US 2002/0004909 A1
(43) Pub. Date: Jan. 10, 2002

(54) ID information management system and method

(76) Inventors: Yoichiro Hirano, Kanagawa-ken (JP); Yoshiyuki Kitahara, Tokyo (JP); Yukiyasu Hirose, Kanagawa-ken (JP); Kentato Ejima, Tokyo (JP)

Correspondence Address: Pillsbury Winthrop LLP, Intellectual Property Group, Calendar/Docket Dept., 50 Fremont Street, San Francisco, CA, 94105, US

(21) Appl. No.: 09/884,876

(22) Filed: Jun. 18, 2001

(30) Foreign Application Priority Data
Jun. 20, 2000 (JP) 2000-185143

(51) Int. Cl. G06F 12/14; G06F 17/60

(52) U.S. Cl. 713/200; 713/182; 705/51; 707/9

(57) ABSTRACT

Systems and methods for managing information and access to information in an information management system comprising an ID control center, at least one owner terminal, at least one third-party terminal, and a network linking the ID control center and the terminals. The present invention provides four types of ID management methods and systems. Service type 1 enables an ID holder to upload, store, and edit the information assigned to the ID via an ID control center. Service type 2 enables an information requester to access the information assigned to an ID with the permission of the ID holder. Service type 3 enables an ID holder to utilize the information assigned to the ID to obtain products and/or services from a third party via an ID control center. Finally, service type 4 enables an ID holder to place an order for a third party's products and/or services to be delivered to another ID holder, using the second ID holder's ID information and with the second ID holder's permission.

### FIELD OF THE INVENTION

This invention relates generally to database systems and methods and, more particularly, to systems and methods for storing, securing, and managing name card and other identification information.

### BACKGROUND OF THE INVENTION

Currently, there are numerous name card information management systems that register and collectively manage in databases information recorded on name cards where the name card information can be accessed by third parties. KOKAI Gazette H6 [1994]-223086 discloses such a name card management system and the name cards that conform to the management system. In addition, KOKAI Gazette H10 [1998]-105610 discloses a name card information management server, name card reading and writing devices, electronic name card devices, telephone devices, and a name card information management system. Furthermore, KOKAI Gazette H10 [1998]-283407 discloses a name card management system that is capable of obtaining corporate information.

In these prior art name card management systems, it is common for access to be restricted according to the intentions of the ID holder (i.e., the information provider), but access normally cannot be limited by another person who merely has authority to retrieve the information.

Also, in prior art name card management systems, the systems manage name card and corporate information (i.e., information about persons and corporations). They cannot, however, manage order information for products or services, especially those to be provided by third parties.

Furthermore, in prior art name card management systems, sophisticated data processing, such as history management for persons accessing information and sorting of access information by classes, cannot be done as part of access management.

Accordingly, there remains a need for an ID information management system that can perform sophisticated access management that is absent in prior art name card management systems.

### SUMMARY OF THE INVENTION

The present invention provides systems and methods for storing, securing, and managing name card and other identification information. More specifically, the present invention provides four types of ID management methods and systems. Service type 1 enables an ID holder to upload, store, and edit the information assigned to the ID via an ID control center. Service type 2 enables an information requester to access the information assigned to an ID with the permission of the ID holder. Service type 3 enables an ID holder to utilize the information assigned to the ID to obtain products and/or services from a third party via an ID control center. Finally, service type 4 enables an ID holder to place an order for a third party's products and/or services to be delivered to another ID holder, using the second ID holder's ID information and with the second ID holder's permission.

An information management system in accordance with the present invention comprises an ID control center, at least one owner terminal, at least one third-party terminal, and a network linking the ID control center an d the terminals. The ID control center manages information associated with the IDs of ID holders, and compiles and manages a history file of access to the ID information. It also translates the ID information into appropriate formats used by the computer terminals of parties requesting the information.

It is an objective of this invention to enable a third party to access information associated with an ID by using a point system. By purchasing the number of points required for specific information, the third party can access the information without requesting permission from the information provider.

It is another objective of the present invention to enable access to information by using agent software to establish a dialog between the requesting party and the information provider to clarify the purpose of the information request.

It is still another objective of the present invention to restrict access by requiring the information requesting party to have the required meta-information for the information requested.

It is still another objective of the present invention to compile a history file of third parties that have accessed one's information in a “taken list”, allowing access conditions to be changed according to the result of the compilation.

It is still another objective of the present invention to automatically translate information into specific information structure formats used by computer terminals of parties requesting the information.

It is still another objective of the present invention to manage product and service information in addition to information regarding individuals or corporations.

### BRIEF DESCRIPTION OF THE DRAWINGS

FIG. 1 is a schematic view of an ID information management system in accordance with the present invention.

FIG. 2 is a schematic view of an ID control center in accordance with the present invention.

FIG. 3 is a flowchart illustrating the operation of a service type 1 ID information management system in accordance with the present invention.

FIG. 4 is a front view of a name card in accordance with the present invention.

FIG. 5 is a flowchart illustrating the setting and changing of access authorization when a party accesses ID information in an ID control center in accordance with the present invention.

FIG. 6 is a flowchart illustrating a service type 2 ID management in accordance with the present invention.

FIG. 7 is a flowchart illustrating a service type 2 ID management in accordance with the present invention.

FIG. 8 is a flowchart illustrating a service type 3 ID management in accordance with the present invention.

FIG. 9 is a flowchart illustrating a service type 4 ID management in accordance with the present invention.

FIG. 10 illustrates a point system in accordance with the present invention.

FIG. 11 is a diagram illustrating the agents of two ID holders establishing a dialog in order to provide information requested by the accessing party.

FIG. 12 illustrates the creation and assignment of fixed and variable tags for information items in accordance with the present invention.

FIG. 13 illustrates the transmission of scrambled information to the requesting party in accordance with the present invention.

FIG. 14 illustrates the flow of transmission of specification information and order information in accordance with the present invention.

FIG. 15 illustrates the access restrictions for the items of an ID information according to the contents registered on the taken list stored in a history information file, and extraction and provision of the ID information to a third party in accordance with the present invention.

FIG. 16 illustrates the use of an information translation table and a translation engine to translate the structure system of an ID information 122 between ID holder A and ID holder B in an ID control center in accordance with the present invention.

FIG. 17 illustrates using an ID control center in accordance with the present invention to search for an ID holder registered with the ID control center.

### DETAILED DESCRIPTION OF THE INVENTION

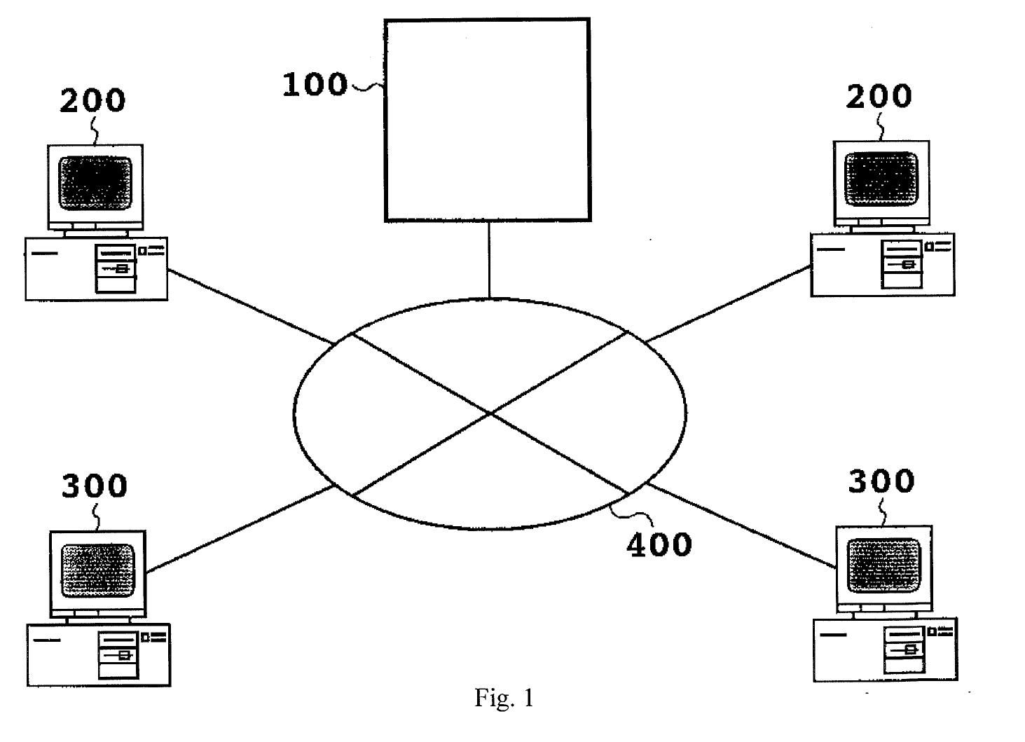

FIG. 1 provides a schematic view of an ID information management system in accordance with the present invention. The ID information management system includes ID control center 100, at least one owner terminal 200, at least one third-party terminal 300, and network 400, wherein the terminals 200 and 300 are each connected to ID control center 100 via network 400.

In general, ID control center 100 has the capability to store and manage information assigned to an ID (“ID information”), which identifies an ID holder, and access history of the ID information. It also has the capability to translate an ID information from one format into a different format. The functions and capabilities of ID control center 100 will be discussed in detail below. Owner terminal 200 is a terminal used by an ID holder to register, access, update, edit or delete his ID information stored in ID control center 100. The ID holder can also use owner terminal 200 to access ID information of another ID holder under certain predetermined conditions, which will be described below. Third-party terminal 300 is a terminal used by a person (whether or not this person has an ID) who wishes to access a particular ID information stored in ID control center 100 under certain predetermined conditions, which will be described below. As used herein, owner terminal 200 and thirdparty terminal 300 may be any kind of terminal as long as they have network connection capabilities and functions for sending and receiving information to and from other terminals (e.g., servers, etc.). For example, such a terminal may be a radio call terminal, a PHS terminal, a portable terminal, or an information processing terminal such as a PC or a PDA, etc. Owner terminal 200 and third-party terminal 300 may also be equipped with software for viewing information on the Internet (e.g., browser software, etc.). Network 400 connects ID control center 100, owner terminal 200, and third-party terminal 300 to each other and may be equipped with any or all of the following: access to the Internet, one or more intranets, LANs, public telephone networks (including both analog and digital), portable circuit exchange networks or portable packet exchange networks such as PDC and PDC-P systems, radio call networks, PHS networks, or satellite communications networks.

As used herein, an identification or “ID” has the following properties:

Issuing of ID

An ID may be issued to a natural person or corporation in any format as long as it is issued without duplication. For example, an ID may be issued consisting of numerals only, alphabetical letters only, or a combination of both numerals and letters. As such, the ID can be conveyed from person to person, between a person and a machine, or between machines. IDs can be entered into and recognized by a machine via means such as optical readers or keyboards with numerical keypads and alphabetical letters.

Display of ID

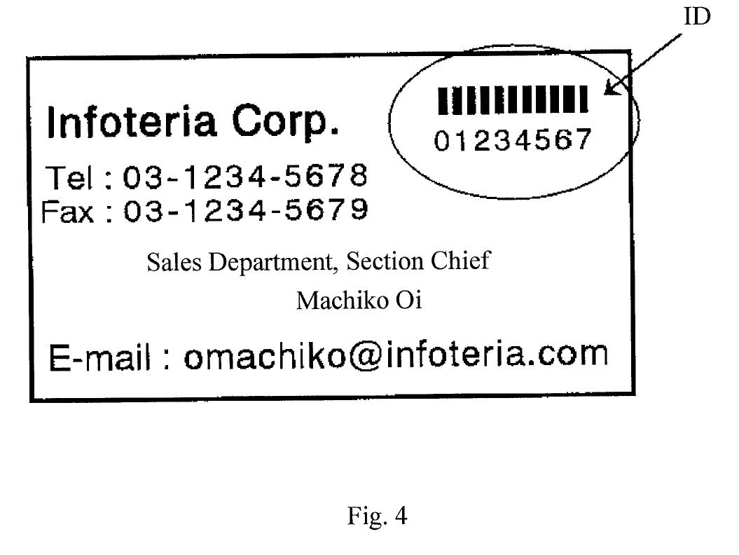

An ID may be linked to a product or service, and can be thus displayed anywhere on the product or service by printed means, such as a sticker or a seal, so that it can be recognized by people as well as devices. As described above, the IDf can be displayed as numerals and/or letters. Therefore, people are able to read the ID. If the ID is printed, it may be recognized by an optical reading device such as an image scanner. In addition, IDs can be converted into bar codes for display. By this means, they can be recognized by bar-code readers. FIG. 4 illustrates one example when an ID is displayed on a name card as a bar code plus numerals.

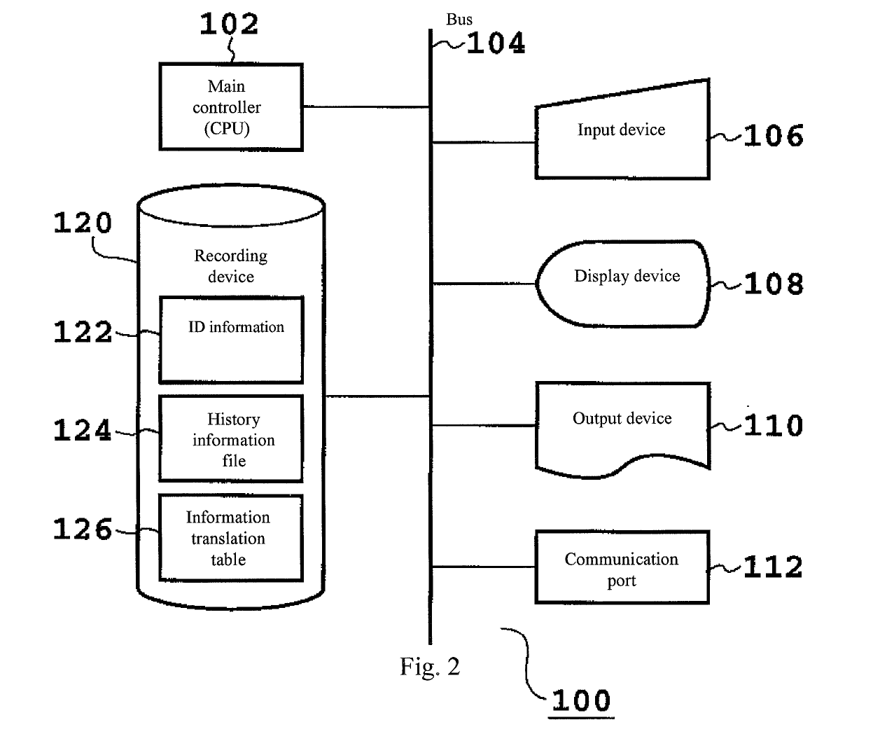

Turning to FIG. 2, a schematic view of ID control center 100 is illustrated in accordance with the present invention. Preferably, ID control center 100 includes at least one main controller 102 (i.e., a control means such as a central processing unit or CPU, hereafter collectively referred to as “CPU 102”) programmed to manage the entire ID control center 100, which includes an input device 106 (e.g., one or more input tools such as mice, keyboards, image scanners, digitizers and the like) connected to CPU 102 via a bus 104, a display device 108 for monitoring data, an output device 110 such as a printer, and a communications port 112 which includes one or more modems, terminal adapters, DSUs or the like connected to a communications line (including wired/wireless, LAN/Internet, and analog/digital lines). Input device 106, display device 108, and output device 110 may also be connected to CPU 102 via respective input/output interfaces.

CPU 102 has a memory device 120 for storing control programs such as an operating system (OS), programs that stipulate various operating procedures and the like, and data. The programs are used by CPU 102 to perform information processing for executing various types of ID management. Memory device 120 is a storage means such as a hard disk, a flexible disk, an optical disk, or a similar storage apparatus. In addition to programs, memory device 120 stores various tables, files, databases and the like used in various processes, and holds at least ID information 122, history information 124, and information translation table 126. Input device 106 allows a user to input various types of data. It includes one or more input tools such as mice, keyboards, image scanners and the like for selecting onscreen menus and entering data. Display device 108 displays various types of menus, processing results and the like, and may be a monitor, for example. Output device 110 outputs processing results to media such as paper and may be, for example, a printer device or the like. Communications port 112 communicates data with other terminals via a communications line. ID control center 100 may be constructed by connecting peripheral devices such as printers, displays, and image scanners, etc., to known information processing devices such as personal computers, workstations, PHS terminals, portable telephone terminals, mobile telecommunications terminals or information processing terminals such as PDAs, etc., and loading the information processing devices with software (including programs, data and the like) that implement the ID management method of the present invention.

Turning now to FIGS. 1-17, four different management services are described and the operation of an ID information management system with respect to each of the four management services is illustrated. Briefly and generally, service type 1 enables an ID holder to upload, store, and edit the information assigned to the ID via the ID control center 100. Service type 2 enables an information requester to access ID information 122 with the permission of the ID holder. Service type 3 enables an ID holder to utilize ID information 122 to obtain products and/or services from a third party via ID control center 100. Finally, service type 4 enables an ID holder to place an order for a third party's products and/or services to be delivered to another ID holder, using the second ID holder's ID information 122 and with the second ID holder's permission.

Service Type 1

Service Type 1 is a service in which the ID holder can manage ID information 122 via ID control center 100. ID control center 100 and the ID holder are connected via the Internet, and ID information 122 can be structured and stored in a data format such as XML or RDB. Preferably, the chosen data format or formats are prepared in advance in a unified manner by ID control center 100. To use ID control center 100 to manage an ID information 122, the corresponding ID holder first identifies himself or herself, then uploads and stores ID information 122 into ID control center 100. The ID holder can subsequently edit the stored ID information 122. Conversely, persons who are not the ID holder cannot add to, change, or delete from ID information 122 without the permission of the ID holder. The ID holder can also specify an agent (e.g., agent software) in place of the ID holder.

Referring specifically to FIGS. 1-3, the operation of an ID information management system in accordance with a service type 1 embodiment is illustrated. In this example, a new ID information 122 is uploaded and stored in ID control center 100 as follows:

The ID holder first transmits proof of identity (ID+password or the like) from an owner terminal 200 to ID control center 100 (step S302). Pre-registered personal information is then referenced in ID control center 100 to confirm the identity of the ID holder (step S304). Once the identity of the ID holder is confirmed, the ID holder transmits an application to register the ID for uploading the new ID information 122 into ID control center 100 (step S306). Upon receiving the transmission of the registration application, a data storage area within memory device 120 is automatically secured for the ID in ID control center 100 (step S308). A data entry form is then automatically generated in the ID control center and transmitted to the owner terminal 200 (step S310). The data entry form is received in the owner terminal 200 (step S312). The ID holder then completes the data entry form at the owner terminal (step S314), and transmits (synchronously or asynchronously) the input data (i.e., ID information 122) from owner terminal 200 to ID control center 100 (step S316). The II) information 122 is then received at ID control center 100 (step S318). The ID information 122 is then stored in the specified data storage area of memory device 120 in ID control center 100 (step S320).

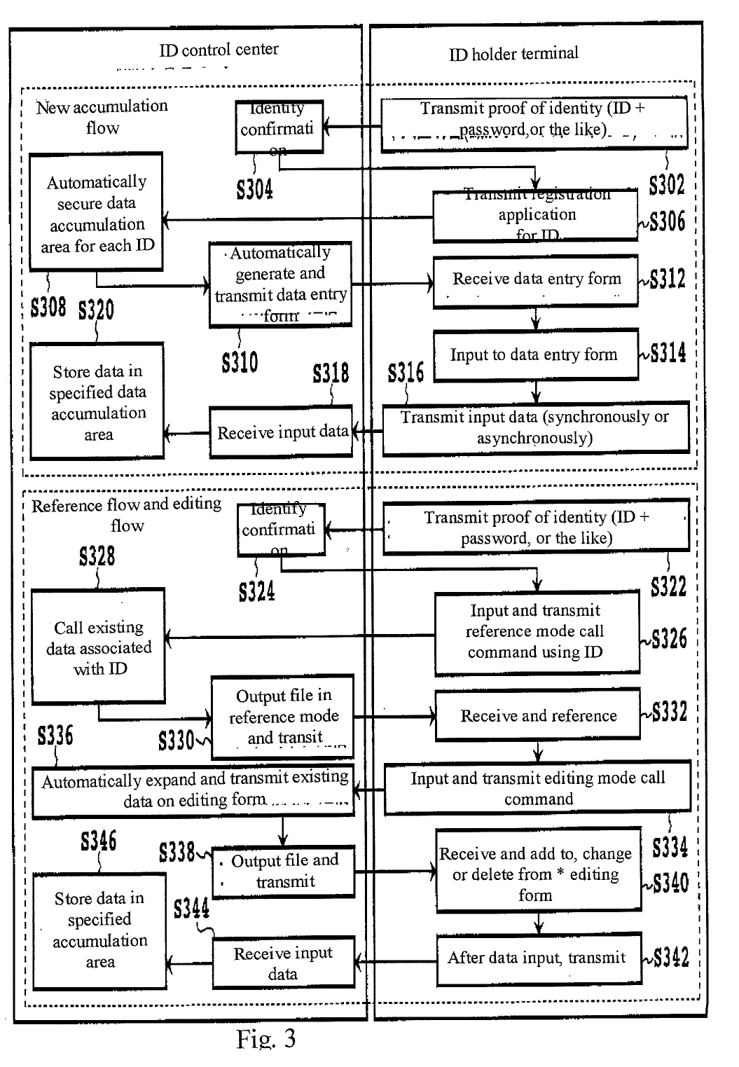

The second part of FIG. 3 depicts the flow of reference and edited ID information 122 registered in ID control center 100. Transmission of ID holder identity authentication (ID +password or the like) is first performed at owner terminal 200 (step S322). The identity of the ID holder is confirmed using pre-registered personal information in the ID control center 100 (step S324). The ID is then used at the owner terminal 200 to input and transmit the reference mode paging command (step S326). Existing data associated with the ID (i.e., existing ID information 122) is called up in ID control center 100 (step S328). The ID control center 100 then transmits ID information 122 in the reference mode to owner terminal 200 (step S330). Upon receiving ID information 122 at owner terminal 200 (step S332), the ID holder may input the edit mode paging command at owner terminal 100 and transmit that paging command to ID control center 100 (step S334). The ID control center 100 deploys and transmits existing ID information 122 in the editing form (step S336). ID information 122 files are subsequently output and transmitted from the ID control center 100 to the owner terminal 200 (step S338). ID information 122 is then received and edited in the editing form at owner terminal 200 (step S340). After the If) holder enters the edited data, the edited ID information 122 is transmitted from owner terminal 200 to ID control center 100 (step S342). Finally, the edited ID information 122 is received in ID control center 100 (step S344) and stored in the specified data storage area within memory device 120 (step S346).

Control of IDs and Access Authorization for Service Types 2-4

The ID control center 100 controls access to ID information 122 so that ID information 122 can be accessed according to the intention of the ID holder. Generally, ID control center 100 determines whether access should be granted to a particular information requester based on the ID of the information requester or the purpose of the access. For example, the ID holder or an agent of the ID holder can communicate with ID control center 100 and authorize the information requester to have access to ID information 122 prior to the party's attempt to access the information, such that the information requester's ID would indicate to ID control center 100 of the authorization. Alternatively, the information requester can ask for such authorization when attempting to access ID information 122. Access can also be controlled by creating a set of governing rules or procedure or an “access authorization policy” within ID control center 100. For example, an information requester can be given access to the ID information 122 for certain purposes specified in the policy. Such a policy can be created by ID control center 100 as a default for all ID holders or it can be personalized by each and every ID holder; or it can be first created as a default access control mechanism and subsequently be modifiable by an ID holder.

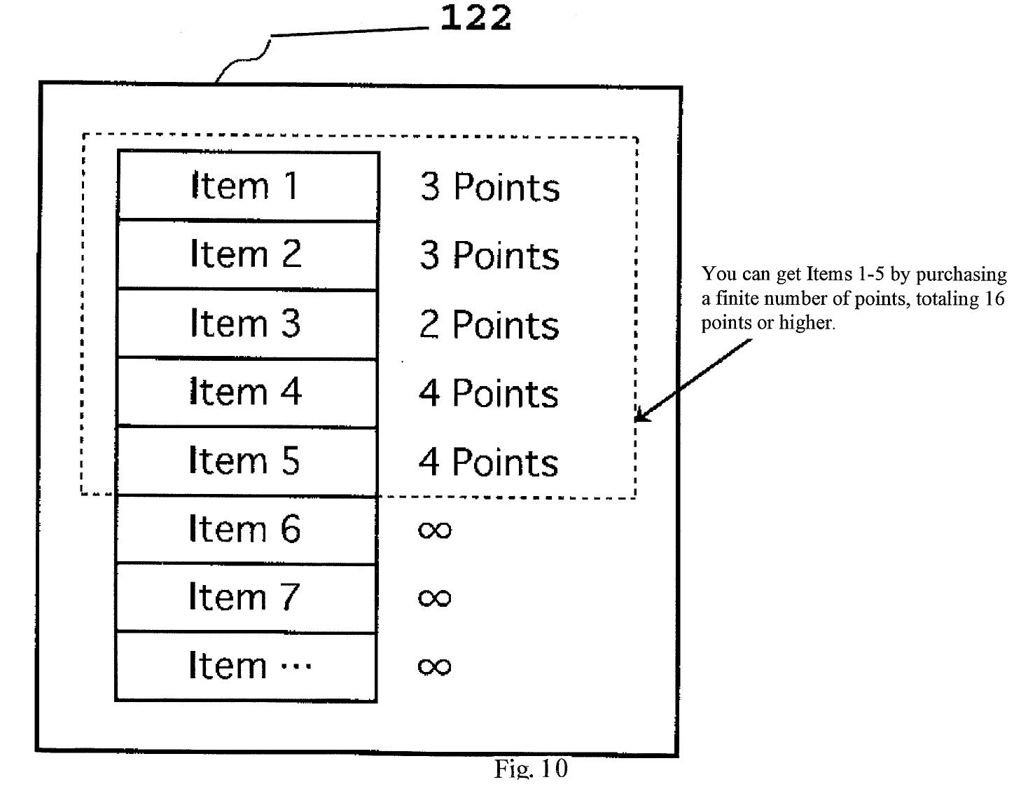

A point system for purchasing access to information such as ID information 122 may also be used. In other words, no absolute access restriction is set up and theoretically all information can be disclosed (i.e., purchased), but access to a particular piece of information can be made practically impossible depending on the number of points assigned to that information. For example, as illustrated in FIG. 10, points are set in advance for every information item contained in ID information 122, and finite points are given to items that may be purchased while items not to be disclosed are set at infinity. Therefore, the ID of an ID holder, an information item, the data indicating the content corresponding to the information item (for example, “Ichiro Tanaka” for the information item “Name”), and the number of points required for a third party to access the data are transmitted from owner terminal 200 to ID control center 100; and the ID, information item, data corresponding to the information item, and the number of required access points are stored in ID control center 100. Consequently, a third party wishing to access a particular piece of data may purchase the corresponding required points in advance from a provider. Subsequent to the purchase, the third party may use a third-party terminal 300, as illustrated in FIG. 1, to transmit the number of purchased points and the ID of the third party to ID control center 100, and both the third party ID and the number of purchased points are stored in ID control center 100. Since it is impossible to purchase an infinite number of points, any ID information 122 can be prohibited from access by a third party by assigning an infinite number of points to that ID information 122. An access request from an accessing third party that includes a terminal ID or personal ID, and desired information item may be transmitted from third-party terminal 300 to ID control center 100, and the number of purchased access points corresponding to the terminal ID or personal ID contained in the access request is searched at ID control center 100. The number of required access points corresponding to the information item contained in the access request is also searched at ID control center 100. The number of purchased access points and the number of required access points are compared, and when the number of purchased access points is greater, access is enabled (i.e., data corresponding to the information item is transmitted to the third-party terminal 300), and a point value obtained by subtracting the number of required access points from the number of purchased access points is stored as the new number of purchased access points in ID control center 100. This process eliminates unlimited access.

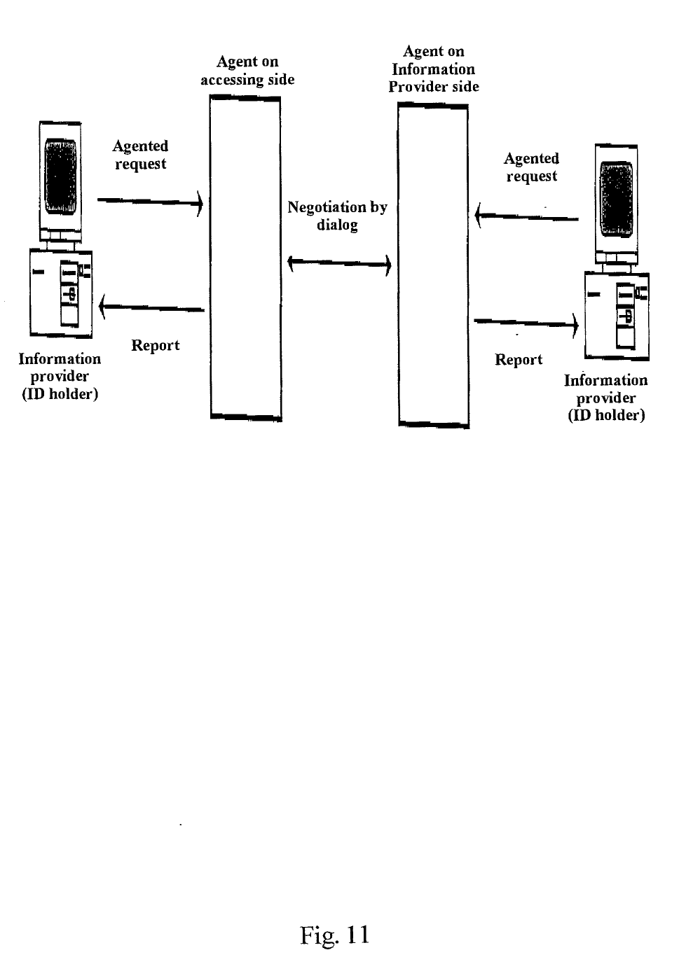

Turning now to FIG. 11, agents (e.g., electronic processes involving agent software or the like) of two ID holders may communicate to allow the information to be accessed by the side requesting it. In other words, for each information item, two agents establish a dialog and information is fetched upon confirming the purpose of the information access. Thus, the information provider does not limit access to information; instead, information is provided by clarifying through a dialog the reason why the accessing side requires such information. The behavior of the two agents is conducted electronically under software control, i.e., using predetermined message text and responses of set format.

First, the ID of the information provider or the provider's terminal, the name and data of the information item, and the access-enabling condition or conditions for a third-party to access the data are all transmitted from an owner terminal 200 to ID control center 100 and stored in ID control center 100. Then, an access request that contains the ID of the requester or the third-party terminal 300, the provider's ID or terminal ID, the name of the information item, and the access request condition is transmitted from the third-party terminal 300 to the ID control center 100, and the ID control center 100 searches for the access-enabling condition of the information item requested. The access request condition contained in the access request is then compared to the access-enabling condition via predetermined talk scripts. If the two conditions do not match, a dialog is established according to the talk script between the owner terminal and the third-party terminal to match the conditions.

The dialog scripts of the two agents are arranged in advance and preferably, the script contents cannot be rewritten or changed in any way by the two parties at will, but individual messages can be added to the scripts according to the intention of the information provider. In other words, the talk scripts may be customized according to the nature of the information exchange between the two parties as approved by the information provider. The result of the agent negotiation is reported to both the information provider and the requester. As an example, a talk script that results in the granting of access of ID information 122 may be as follows:

Agent of information requester on third-party terminal 300: (information request) “I want to access address information.”

Agent of information provider on owner terminal 200: (request disclosure of objective) “Why do you need address information?”

Agent of information requester on third-party terminal 300: (disclosure of objective) “I want to send a direct mailing.”

Agent of information provider on owner terminal 200: (approval) “Your need for the information has been recognized and approved. Please use the system.”

Similarly, a talk script that results in the denial of access of ID information 122 may be as follows:

Agent of information requester on third-party terminal 300: (information request) “I want to access address information.”

Agent of information provider on owner terminal 200: (request disclosure of objective) “Why do you need address information?”

Agent of information requester on third-party terminal 300: (disclosure of objective) “I need it for private reasons.”

Agent of information provider on owner terminal 200: (request disclosure of objective) “Please be more specific.”

Agent of information requester on third-party terminal 300: (ending negotiation) “I have not been told the specific objective, so I will end this request.”

Agent of information provider on owner terminal 200: (confirmation) “Understood.”

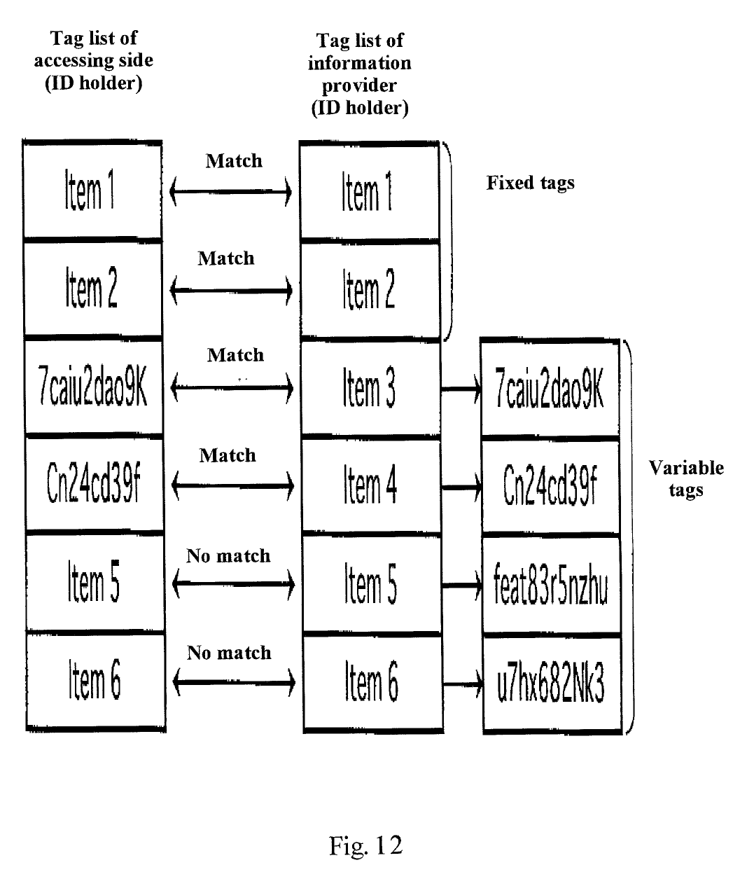

In addition to using the talk scripts, a tag may be created for each individual information item, and access may be enabled only if the tag name entered in an information request matches the tag name of the information item requested. As illustrated in FIG. 12, the information items (e.g., items 1-6 in FIG. 12) uploaded by the information provider are placed in categories of fixed and variable tags. Preferably, the names of the fixed tags are disclosed to the general public or are reported to both the information provider and the requester in advance, while the names of the variable tags are electronically changed so that only the information provider can recognize them.

Therefore, the ID of the information provider or the owner terminal 200, and the tag name and data of an information item are first transmitted from owner terminal 200 to I) control center 100 and stored in ID control center 100. Subsequently, an access request containing the ID of the requester or the third-party terminal 300, the ID of the information provider or the owner terminal 200 to be referenced, and the tag name of the information item is transmitted from the third-party terminal 300 to the ID control center 100. The tag name of the information item contained in the access request is compared to the tag name created by the information provider. If the two tag names match, the data corresponding to the information item is transmitted to third-party terminal 300.

Preferably, the variable tags are created to be time dependent. That is, the names of the variable tags are changed, preferably automatically and electronically, at a predetermined frequency. Thus, by changing the name of a variable tag periodically, a period of validity can be established for access. To prevent anyone from generating and counterfeiting variable tag names, known encryption technology or the like may be used to generate secured variable tag names. Other security means such as limiting the number of information requests or inquiries per information item may also be employed.

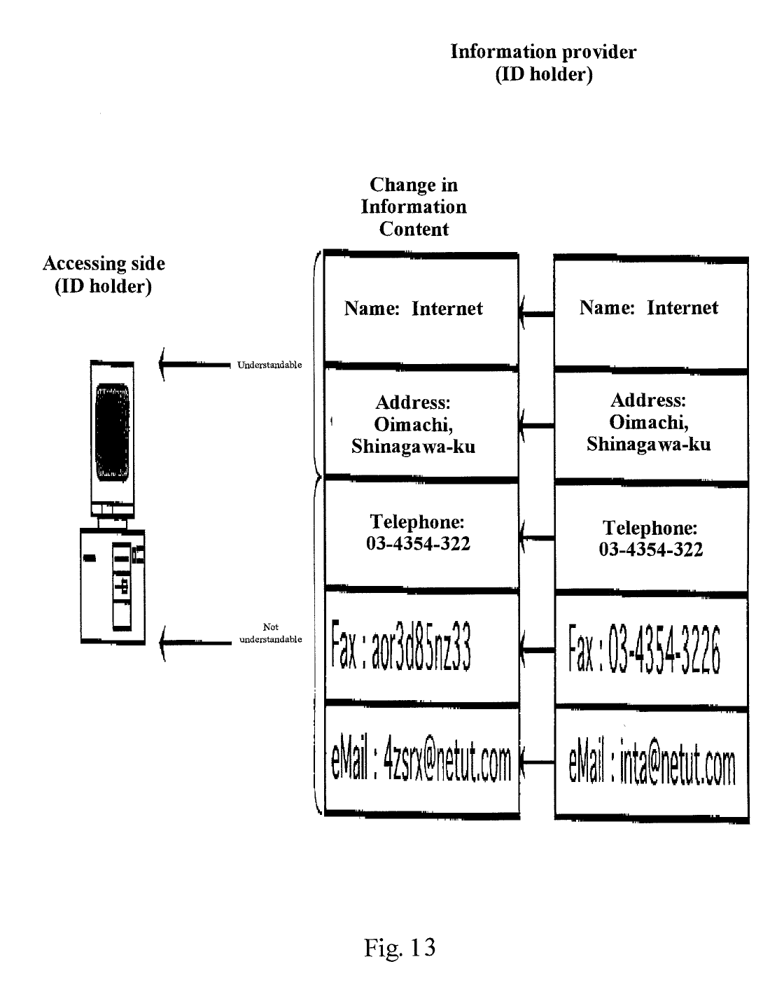

Referring now to FIG. 13, to further protect ID information 122, the information content may be scrambled or otherwise electronically rewritten into an incomprehensible form that cannot be decoded. Therefore, if ID information 122 is accessed without authorization, the information accessed will be incomprehensible to the person accessing such information. The scrambling is managed and executed between the information provider and the ID control center 100, and it is unknown everyone else.

The ID control center 100 controls settings involving the IDs of persons seeking access (persons who use other persons' IDs or “ID users”) and IDs of the persons who are the access targets (ID holders). By managing the access frequency of ID information 122 and other relevant information in a history information file 124, a record of the access behavior of persons accessing ID information 122 can be retained for both the ID holders and the ID users to create restrictions for future access. This presumes that both the ID holders and the ID users have their own IDs.

Every ID holder simultaneously has the statuses of an ID holder and an ID user from the first time he or she exchanges IDs with another ID holder. To manage the statuses of various ID holders and users, ID control center 100 automatically creates a “taken list” (history information of others who have accessed one's own ID information 122) and a “take list” (history information when one has accessed another's ID information 122), which are described below, in history information file 124. Based on the history information 124, therefore, an ID holder can determine to whom the owner's ID has been provided according to the taken list. Similarly, an ID user can find out whose ID they have obtained according to the take list. The scope of access authorization for each ID on the take list is determined according to the intention of the ID holder. It is also possible to preset a scope of access authorization that recognizes any partner from the beginning as the default (i.e., initial value).

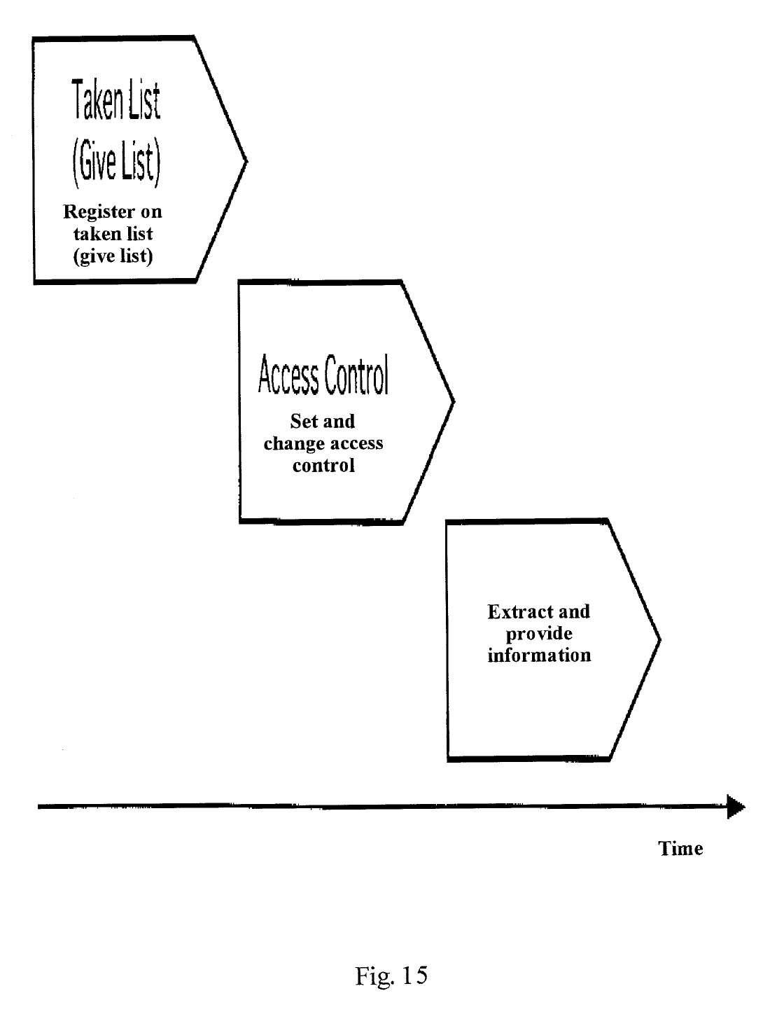

The history registered in the taken list is recorded in history information file 124 in ID control center 100. Preferably, ID control center 100 records a history of registration in the taken list rather than a history of information accessed. For example, the taken list (or “give list”) includes IDs of partners who have been provided with the list owner's ID, but it does not contain the actual information or meta-information (i.e., information that specifies other information). Turning to FIG. 15, access authorization for various items of ID information 122 is set and/or changed according to the contents registered on the taken list, which is stored in history information file 124, and ID information 122 is extracted and provided to a third party accordingly.

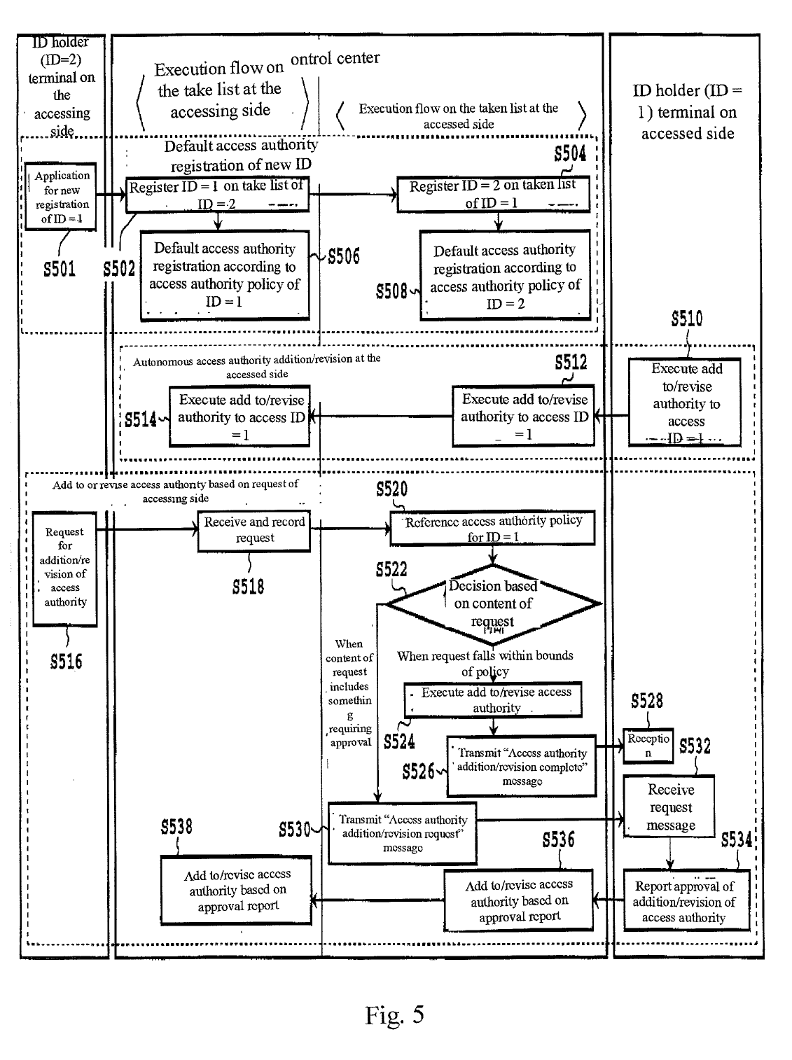

FIG. 5 is a flowchart illustrating one example of setting and changing access authorization when a person accesses ID information 122 via ID control center 100. FIG. 5 describes ID control center 100 in terms of the execution flow in the take list of the accessing party (ID=2) and the execution flow in the taken list of the accessed party (ID=1).

First, the default access authorization registration for new IDs will be described. A new registration application for ID=1 is made at the accessing side (step S501). ID=1 is thus registered on the take list of ID=2 at ID control center 100 (step S502). Likewise, ID=2 is registered on the taken list of ID=1 (step S504). Default access authorization registration is performed according to the access authorization policy of ID=1 at the ID control center 100 (step S506). Default access authorization registration is also performed according to the access authorization policy of ID=2 at the ID control center 100 (step S508).

Access authorization is reset for all ID owners listed on the take list of ID=2 or the taken list of ID=1 in the ID control center 100. For example, when the ID of another person is written on the taken list, the access condition may be changed from the default level (for example, level 0, which may indicate that access is not authorized) to a specific level. Therefore, access conditions can be changed immediately when an ID registration history is recorded.

Next, the autonomous editing of the access authorization of the accessed party will be described. First, an addition/revision request for access authorization for ID=1 is made at the ID holder (ID=1) terminal (step S510). Then, the addition/revision for access authorization for ID=1 is performed at the ID control center 100 (steps S512 and S514).

Next, adding to and revising access authorization based on a request from the accessing party will be described. First, a request to add to or revise access authorization is made at the ID holder (ID=2) terminal at the accessing side (step S516). Once the request is received and recorded at the ID control center 100 (step S518), the access authorization policy of ID=1 is referenced via ID control center 100 (step S520). A decision is then made according to the content of the request by ID control center 100 (step S522). If the request is within the bounds of the policy, the addition/revision of access authorization is performed by ID control center 100 (step S524). A message indicating the completion of the addition/revision of access authorization is then sent from ID control center 100 (step S526). The ID holder (ID=1) terminal at the accessed side receives the message (step S528). If the request contains something requiring approval, ID control center 100 sends an addition/revision of access authorization request message (step S530), and the ID holder (ID =1) terminal at the accessed side receives the request message (step S532). The ID holder (ID=1) terminal at the accessed side then sends an approval report for addition/revision of access authorization (step S534). Subsequently, the addition/revision of the access authorization is performed at ID control center 100 based on the approval report (steps S536 and S538).

Service Type 2

This type of service enables an ID user to obtain the permission of an ID holder via ID control center 100 and access ID information 122 of the ID holder. Granting permission to an ID user is performed through ID control center 100. More specifically, the ID user does not directly seek permission from the ID holder, but instead seeks permission through ID control center 100. The ID user can prove his identity using his own ID when applying to ID control center 100 for permission. ID control center 100 has the contact information for the ID holder, and can send a permission application by automated means such as e-mail. Upon receiving the response from the ID holder via similar electronic means such as e-mail, ID control center 100 can automatically interpret access authorization for ID information 122. If the request is within the bounds of the access authorization, ID control center 100 automatically sends iD information 122 according to the request of the ID user. Access authorization can also be obtained for specific information at the stage when the associated ID is learned. When ID information 122 contains information that does not require permission of the ID holder, access authorization can be granted automatically as the default for information within that scope. Default access authorization is automatically given at the point when the associated ID is learned, but one's identity must first be proven by means such as providing one's own ID when accessing through ID control center 100.

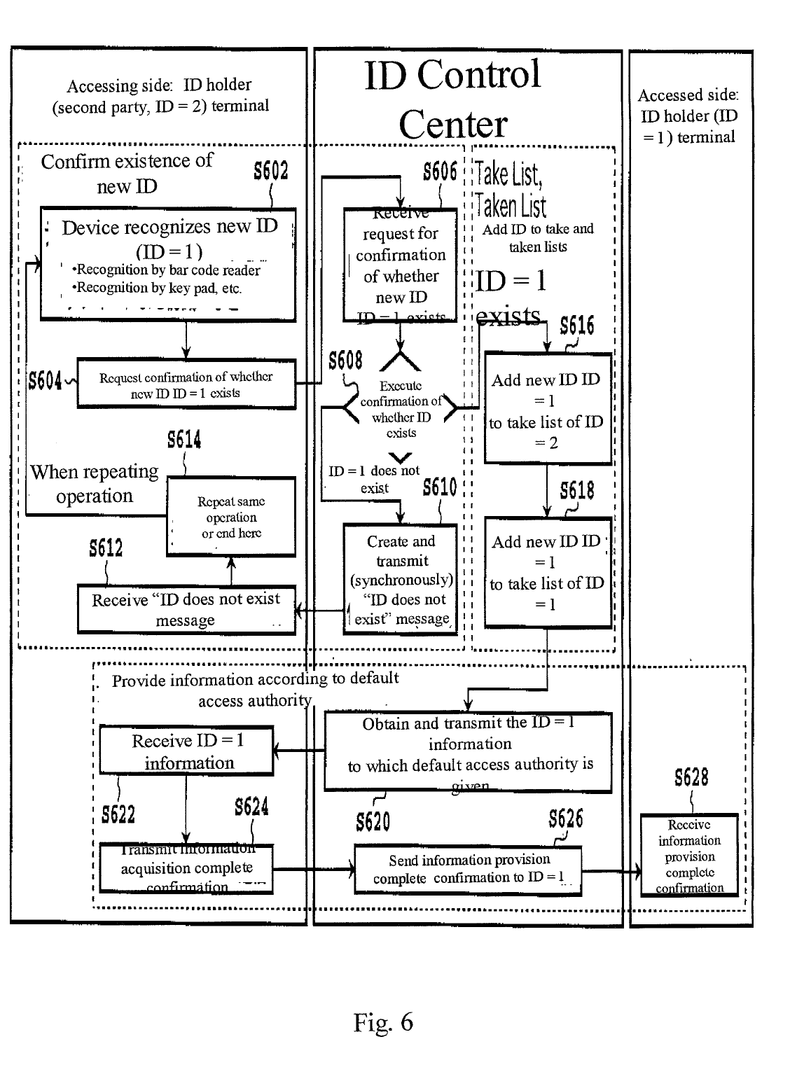

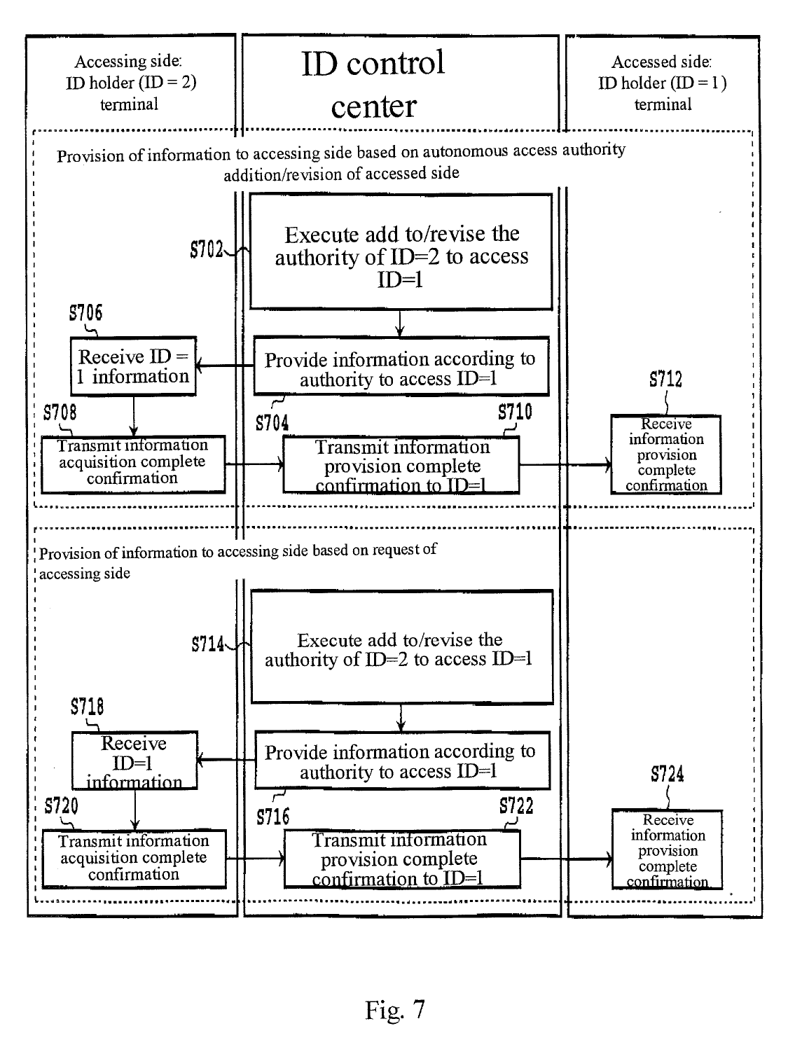

FIGS. 6 and 7 provide a service type 2 example of providing ID information 122 to another person via ID control center 100. First, the existence of a new ID is checked. An automated confirmation of a new ID (e.g., ID=1) is performed at the accessing ID holder (ID =2) terminal by using a device such as a bar-code reader or a keypad (step S602). A request to confirm the existence of new ID (ID=1) is transmitted from the ID=2 terminal (step S604) to ID control center 100. Once the request to confirm the existence of new ID (ID=1) is received at ID control center 100 (step S606), ID control center 100 confirms the existence of ID=1 (step S608). If ID=1 does not exist, ID control center 100 creates and sends (synchronously) a message indicating that ID=1 does not exist (step S610). Upon receiving the message (step S612), the ID=2 accessing terminal determines whether same operation is to be repeated or if the process is completed (step S614). The operation is repeated by returning to step S602.

If ID=1 does exist, an addition of ID is performed to the take and taken lists. That is, new ID (ID=1) is added to the take list of ID=2 and to the taken list of ID=1 in ID control center 100 (steps S616 and S618).

ID information 122 is provided to an information requester according to the corresponding access authorization. First, any ID=1 ID information 122 to which access has been authorized is extracted and transmitted from ID control center 100 to the accessing ID holder terminal (i.e., ID=2 owner terminal 200) (step S620). Once the ID=1 ID information 122 is received by the ID=2 ID holder at the accessing owner terminal 200 (step S622), a confirmation of the completion of information acquisition is transmitted back to ID control center 100 (step S624). A confirmation of the completion of ID=1 ID information 122 provision is transmitted to ID=1 owner terminal 200 from ID control center 100 (step S626). The process ends when the information provision complete confirmation is received by the ID=1 owner terminal 200 (step S628).

Turning specifically to FIG. 7, ID information 122 can be provided to an accessing ID holder based on autonomous addition/revision of access authorization by the accessed ID holder. First, the addition/revision to access authorization for ID information 122 (ID=1) is performed in ID control center 100 based on the instructions of ID=1 ID holder, as described above (step 702). ID information 122 of ID=1 is then transmitted from ID control center 100 according to the ID=1 access authorization (step S704) and received at the ID=2 owner terminal 200 (step S706). A confirmation of the completion of information acquisition is transmitted from the ID=2 owner terminal 200 to ID control center 100 (step 708). Upon receiving the confirmation, ID control center transmits a confirmation of the completion of information provision to the ID=1 owner terminal 200 (step 710). The process is complete when the confirmation of the completion of information provision is received by the ID=1 owner terminal 200 (step 712).

Still referring to FIG. 7, ID information 122 maybe provided to an accessing party based on the request of the accessing party. First, the addition/revision to access authorization for ID information 122 (ID=1) is performed in ID control center 100 based on the request of ID=2 ID holder, as described above (step 714). ID information 122 of ID=1 is then transmitted from ID control center 100 according to the ID=1 access authorization (step S716) and received at the ID=2 owner terminal 200 (step S718). A confirmation of the completion of information acquisition is transmitted from the ID=2 owner terminal 200 to ID control center 100 (step 720). Upon receiving the confirmation, ID control center transmits a confirmation of the completion of information provision to the ID=1 owner terminal 200 (step 722). The process is complete when the confirmation of the completion of information provision is received by the ID=1 owner terminal 200 (step 724).

Service Type 3

Service type 3 enables an ID holder to use his ID information 122 to obtain products and services of a third party registered with ID control center 100. When products and/or services are obtained from third parties by this means, there is no longer the need to give out information (other than the ID) item by item. In other words, the ID holder would need only his ID to access and provide third parties his ID information 122 (e.g., name, address, etc.) to obtain products and services from the third parties. Typically, the ID information 122 provided to a third party for delivery of goods and services includes name, address, telephone number, fax number, and email address. Additional information required to complete the product or service order is information specifying the product or service (e.g., numbers of a desired product registered in ID control center 100, etc.).

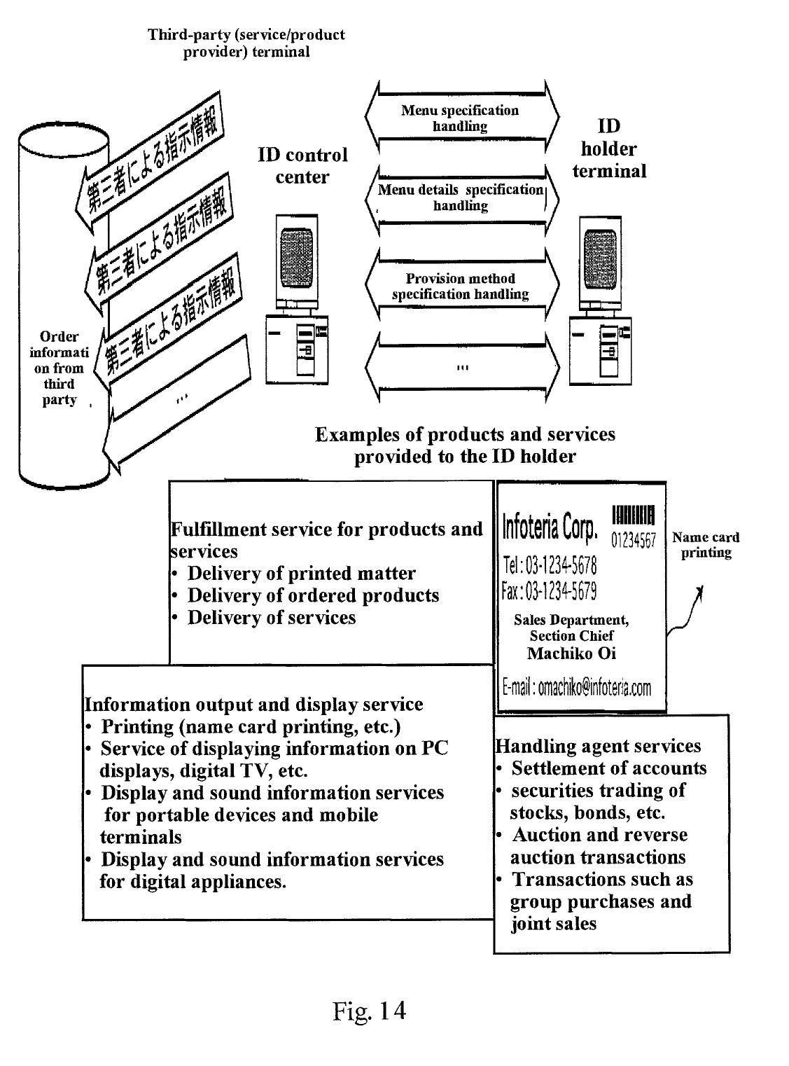

Information for ordering products and services can be stored in ID control center 100 as ID information 122 and have different levels of access authorization than other ID information 122. FIG. 14 illustrates a sample exchange of information between the ID holder, the third party providing products and/or services, and ID control center 100. The ID holder and the third party exchange via their terminals “specification” information, which refers to simplified information that the third party uses for ordering and delivering products and services, but it does not include information that the third party uses internally for producing and performing the products and services. Upon collecting the specification information from the ID holder, the third party transmits to ID control center 100 “order information,” which refers to information of the products and services to be provided by the third party to the ID holder. The order information is transmitted to ID control center 100 based on the ID holder's permission, and it is stored in recording device 120 as ID information 122. Once order information is generated, it can be referenced in the future when the same product or service is needed again.

Therefore, when obtaining a product or service from a third party, the ID holder may be required to send only the order information to the third party. In other words, when the third party already has the necessary personal or corporation information (e.g., name card information, etc.) linked to the order information, the transmission of such information is not needed. For example, assume the service provided by the third party is printing business cards. After the order information “Make name card ID=1” is transmitted to the third party, the third party can print the business cards based on the company name, job title, personal name, and contact information of ID=1 linked to the corresponding order information. In addition, by including information indicating the link destination in the order information, the personal or corporation information can be managed at the link destination. The link destination may be a party that is neither ID control center 100 nor the third party. Alternatively, personal and corporate information may be sent wrapped with the order information. In other words, it may be sent in the format of an order form. This alternative allows the information sent to take the form of an order rather than personal or corporation information.

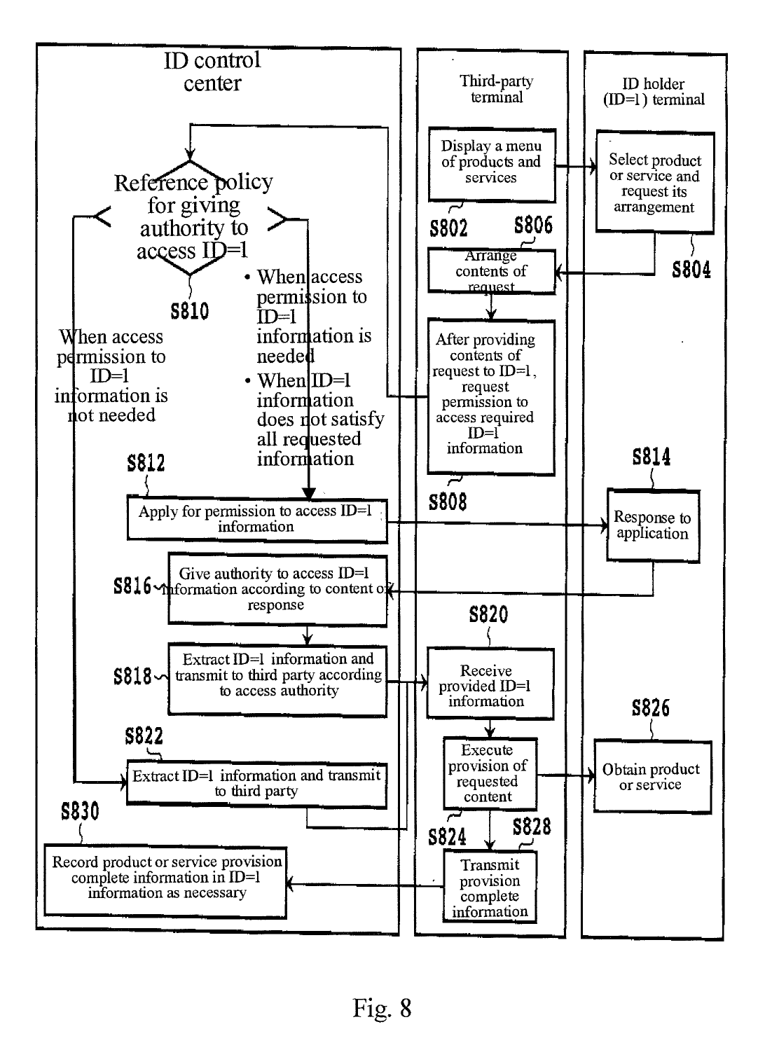

Referring to FIG. 8, an example of obtaining a third party product or service using ID control center 100 in accordance with the present invention is provided. First, a product/service menu is displayed on third-party terminal 300 (step S802). A product or service is selected and a request for delivery is made on the owner terminal 200 for the ID holder (ID=1) (step S804). Preparation according to the content of the request is performed by the third party (step S806). Then, a request for permission to access ID=1 information required to provide the requested product or service is transmitted from the third-party terminal 300 to ID control center 100 (step S808). The access authorization policy of ID=1 is referenced at ID control center 100 (step S810). If permission to access is needed for the ID=1 information or if the ID=1 information does not contain all of the requested information, ID control center 100 requests for permission to access ID=1 information (step S812). A response granting access is sent from the owner terminal 200 for the ID holder (step S814). Then, authorization to access the ID=1 information is granted by ID control center 100 according to the content of the response (step S8 16). The ID=1 information is extracted according to the access authorization level granted at ID control center 100 and sent to the third party (step S818) and received at the third party terminal 300 (step S820). When permission to access the ID−1 information is not required, ID−1 information is extracted and sent to the third party by ID control center 100 without asking the ID holder (step S822). Once the required ID=1 information is received by the third party, the requested products or services is delivered to the ID holder (steps S824 and S826). Information regarding the completion of the requested product and/or service provision is transmitted by the third-party terminal to ID control center 100 (step S828). Finally, the product/service provision completion information is recorded in the ID=1 ID information 122, as necessary, in II) control center 100 (step S830).

Service Type 4

In service type 4, an ID holder (ID=2) can obtain the permission of another ID holder (ID=1) and use the ID information 122 (ID=1) to order products or services from a third party via ID control center 100 on behalf of the ID=1 ID holder. This procedure simplifies the product or service ordering process requested by an ID holder other than the owner of ID information 122. By using ID control center 100, the ID holders ensure that information passed to the third party can be limited to information essential to obtaining the service or product. The third party does not need to have the ID to provide the product or service, because requests and approval of access authorization are always performed between the ID=1 and ID=2 ID holders. Depending on whether the third party has the ID (i.e., ID=1), however, the procedure differs as follows. When the third party does not have the ID, the third party must know the structure information (schema) for ID information 122 so that it can decide whether the information provided by the requester ID holder (ID=2) is sufficient. On the other hand, there is no need to know the schema when the third party has the ID. Depending on the requirement set by the third party, the decision of whether the information provided by the ID holder (ID=2) is sufficient and the need for additional access authorization can be entrusted to ID control center 100.

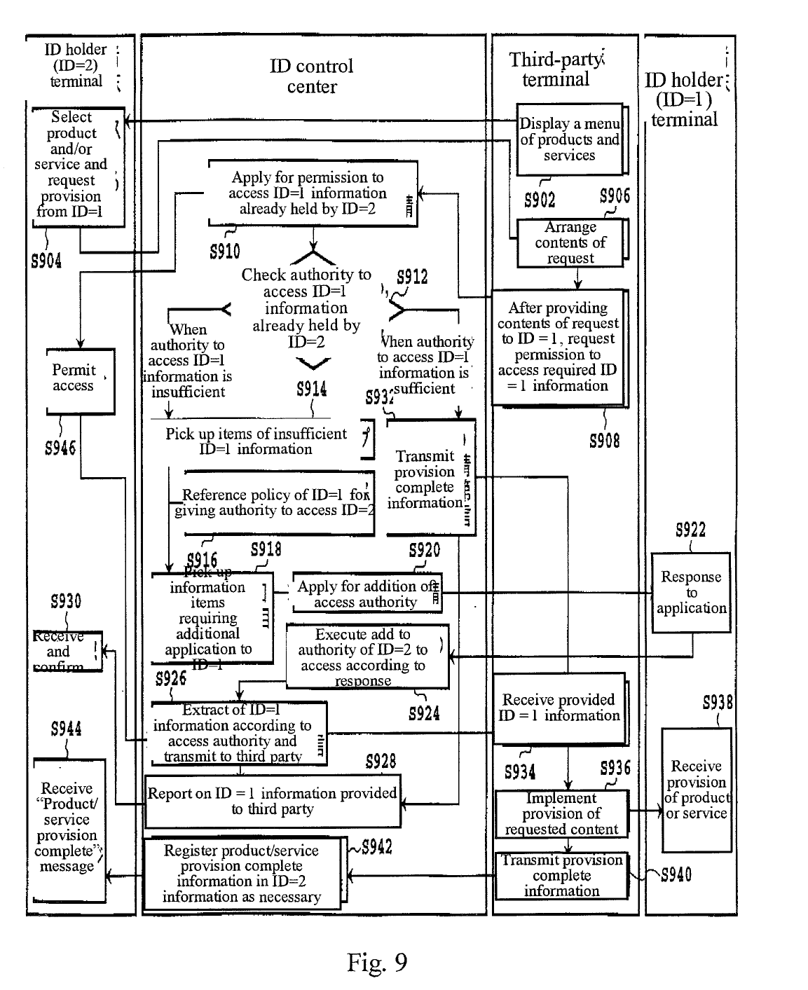

Referring now to FIG. 9, an example of service type 4 is illustrated. First, a product/service menu is displayed on the third-party terminal 300 (step S902). A product or service is selected and a request for delivery is made for the ID=1 ID holder by the ID=2 ID holder on owner terminal 200 (step S904). The contents of the request are then arranged on the third-party terminal 300 (step S906). Then, a request for permission to access ID=1 information required to provide the requested product or service to ID=1 ID holder is transmitted from the third-party terminal 300 to ID control center 100 (step S908). The permission to access the ID=1 information already held by ID=2 is requested at ID control center 100 (step S910) and confirmed by ID control center 100 (step S912). If the level of access authorization is not sufficient to access the ID=1 information, the ID=1 information which is without access permission is extracted at ID control center 100 (step S914). The access authorization policy of ID=1 for ID=2 is then referenced by ID control center 100 (step S916). Then, ID control center 100 picks up the information items that require additional authorization and transmits a request for the required additional authorization to ID =1 ID holder (steps S918 and S920). Then, a response to the authorization request is transmitted from the owner terminal 200 for ID=1 ID holder to ID control center 100 (step S922). The execution of additional access authorization granted to ID=2 ID holder is performed at ID control center 100 according to the content of the response (step S924). The ID=1 information is then extracted according to the access authorization registered with ID control center 100 and sent to the third party (step S926). A report is created regarding the ID =1 information provided to the third party at ID control center 100 (step S928). Then, a confirmation is transmitted by ID control center 100 to the owner terminal 200 for ID=2 ID holder (step S930).

If the access authorization for the ID=1 information is sufficient, the required ID=1 information is extracted and sent from ID control center 100 to the third-party terminal 300 (step S932), and is received at the third-party terminal 300 (step S934). The requested product or service is thus prepared by the third party (step S936) and provided to the ID holder (ID=1) via owner terminal 200 (step S938). A confirmation of the completion of the provision of requested product or service is transmitted by the third-party terminal 300 to ID control center 100 (step S940) and is recorded in the ID=2 ID information 122, as necessary, in ID control center 100 (step S942). A “product/service provision complete” message is then sent by ID control center 100 and received at the owner terminal 200 for the ID=2 ID holder (step S944). In addition, from step S910, access to ID=1 information may be permitted and the process advances to step S926 at the owner terminal 200 for ID=2 ID holder (step S946).

Information Structure

ID control center 100 may be used to set up different information structures (classes) for ID information 122 for each ID holder. In other words, although ID control center 100 manages information using a standard default structure, the ID holders may prefer a different structure. Such customization requires the use of information translation table 126 (see, e.g., FIG. 2), which is a translation table for translating standard default structure into a customized structure. Each ID information 122 with customized structure is managed for each corresponding ID holders. Therefore, when ID information 122 is exchanged with other parties, the need for every ID holder to translate ID information 122 at their end is eliminated by automatically translating ID information 122 to the structure system used by the accessing terminal.

Thus, ID information 122 is first stored in ID control center 100 in the standard default structure. Upon communication with an owner terminal 200 with a different information structure, ID control center 100 records the different information structure in information translation table 126. When ID information 122 is accessed from the owner terminal 200, it can be automatically translated by a translation engine from the standard default structure into the unique structure used by the owner terminal 200.

An information translation table 126 can be created by any individual ID holder with a graphical user interface. Translation according to the appropriate information translation table 126 can be performed automatically and electronically by a translation engine (e.g., CPU 102) when ID information 122 is exchanged between ID holders or between ID holders and ID control center 100.

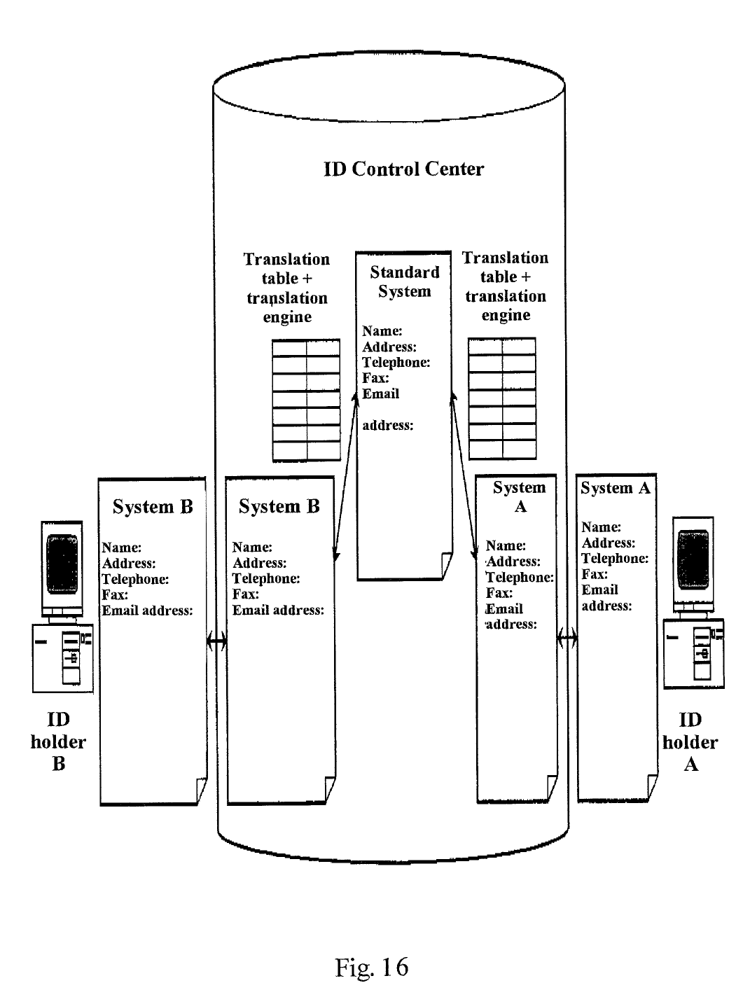

FIG. 16 illustrates an example of translating the structure system of ID information 122 between ID holder A and ID holder B using information translation table 126 and a translation engine in ID control center 100. The standard default structure system managed by ID control center 100 is translated into the unique structure system of the individual ID holders, enabling ID information 122 to be provided to a requesting party.

Printing IDs for Name Cards

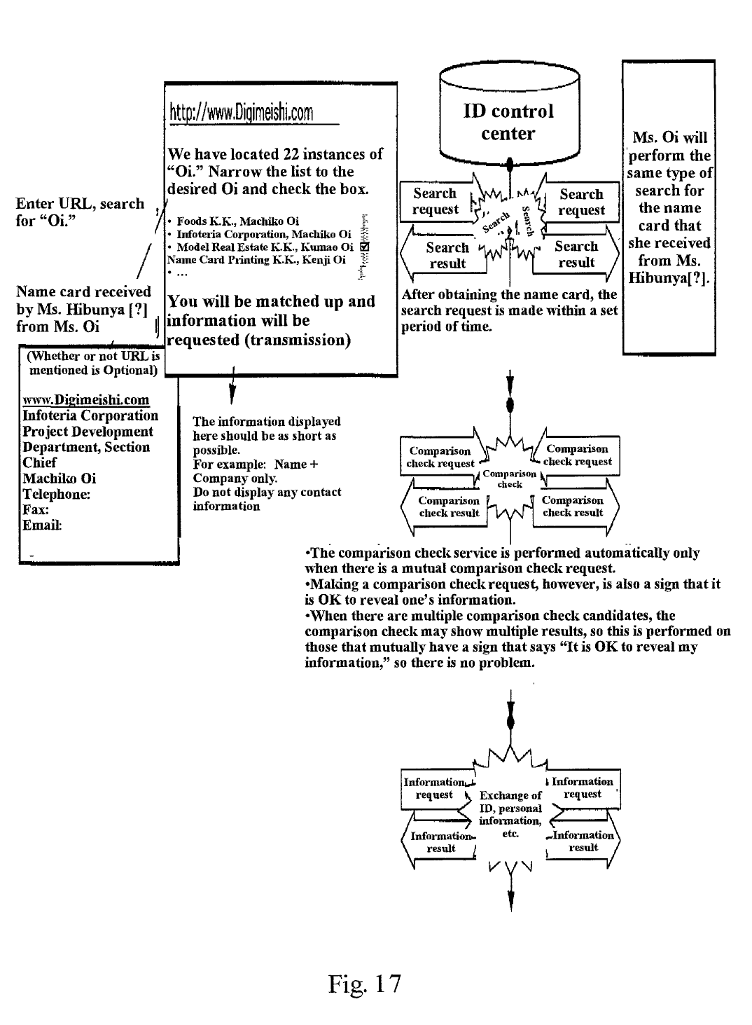

Assuming that the relationship between the ID holders and the I)s is handled by ID control center 100, searching for the IDs can be a service provided by ID control center 100. As illustrated in FIG. 17, the service of searching for registrants is provided by ID control center 100, and provision of ID information 122 and various other types of information is only done when two parties who have mutually exchanged name cards request a partner search and comparison check within a set period of time. Therefore, the URL of ID control center 100 is preferably made public knowledge, so the URL for finding the ID may be printed on a business card. The URL does not necessarily have to be printed on the business card if there is another method of notification, however.

Although the invention herein has been described with reference to particular embodiments, it is to be understood that the embodiments are merely illustrative of the principles and application of the present invention. It is therefore to be understood that various modifications may be made to the above-mentioned embodiments and that other arrangements may be devised without departing from the spirit and scope of the present invention.

For example, the processing executed by CPU 102 as described above may be recorded in the form of a program on a recording medium (e.g., a floppy disk, CD-ROM, DVD-ROM, hard disk, etc.) or on a transfer medium (e.g., a digital data stream, carrier wave, etc.), and can be executed whenever required for each individual device by loading it into the memory of any computer or similar system. In other words, as an alternative, the present invention can be implemented as a computer program product that is loaded into a CPU and executed in a computer system. It is known to one skilled in the art that a computer program capable of executing the four service types of the present invention can be installed on a computer in many forms. Examples of these forms are: (a) information permanently held on a non-writeable recording medium (e.g., ROM, CD-ROM disk, DVD-ROM disk or similar medium that can be read by a computer input/output device) that can be used in a computer; (b) information held in advance on a writeable recording medium (e.g., RAM, floppy disk, hard disk drive device, or similar medium) that can be used in a computer; and (c) information transferred to a computer via a transfer medium such as a telephone line or network using a communications control device such as a modem, a digital data stream or computer data signal carried on a carrier wave.

What is claimed is:

1. A method of managing access to information using an ID information management system comprising at least one owner terminal having an owner terminal ID, an ID control center, and at least one third-party terminal having a third-party terminal ID, the method comprising:
transmitting from the owner terminal to the ID control center an ID of an ID holder, at least one information item having a name and data, and a number of access points required for a third party to access the data of the information item;
storing the ID, the information item, and the number of access points in the ID control center;
transmitting the third-party terminal ID and a number of purchased points from the third-party terminal to the ID control center;
storing the terminal ID and the number of purchased points in the ID control center;
transmitting from the third-party terminal to the ID control center an access request that includes the third-party terminal ID, the ID of the ID holder, and the name of the information item; and
comparing the number of purchased points with the number of access points,
wherein if the number of purchased points is the greater than the number of access points, the data of the information item is transmitted to the third-party terminal and a value obtained by subtracting the number of access points from the number of purchased points is stored as the number of purchased points.

2. A method according to claim 1, wherein the number of access points is set to infinity for the information item to restrict access to the data of the information item.

3. A method according to claim 1, wherein all of the steps are executed by a computer program.

4. A method of managing access to information using an ID information management system comprising at least one owner terminal having an owner terminal ID, an ID control center, and at least one third-party terminal having a third-party terminal ID, the method comprising:
transmitting from the owner terminal to the ID control center an ID of an ID holder, at least one information item having a name and data, and an access-enabling condition for permitting the third-party terminal to access the data;
storing in the ID control center the ID of the ID holder, the information items, and the access-enabling condition;
transmitting from the third-party terminal to the ID control center an access request that includes the third-party terminal ID, the ID of the ID holder, the name of the information item, and an access request condition; and
comparing the access request condition with the access-enabling condition,
wherein if the access request condition does not match the access-enabling condition, a dialog is established according to a predetermined talk script between the owner terminal and the third-party terminal to match the conditions.

5. A method according to claim 4, wherein the talk script is customizable.

6. A method according to claim 4, wherein all of the steps are executed by a computer program.

7. A method of managing access to information using an ID information management system comprising at least one owner terminal having an owner terminal ID, an ID control center, and at least one third-party terminal having a third-party terminal ID, the method comprising:
transmitting from the owner terminal to the ID control center an ID of an ID holder and at least one information item having a required name and data;
storing in the ID control center the ID of the ID holder and the information item;
transmitting from the third-party terminal to the ID control center an access request that includes the third-party terminal ID, the ID of the ID holder, and a requested name of the information item; and
comparing the requested name of the information item with the required name of the information item,
wherein if these requested name of the information item matches the required name of the information item, the data of the information item is transmitted to the third-party terminal.

8. A method according to claim 7, wherein the required name of the information item is fixed.

9. A method according to claim 7, wherein the required name of the information item is variable.

10. A method according to claim 7, wherein all of the steps are executed by a computer program.

11. A method of managing access to information using an ID information management system comprising an ID control center having an ID information and an access condition for accessing the ID information, and at least one third-party terminal having a third-party terminal ID, the method comprising:
compiling in the ID control center an access history information containing the thirdparty terminal IDs of the third party terminals that have accessed the ID information; and
modifying the access condition based on the access history information compiled.

12. A method according to claim 11, wherein all of the steps are executed by a computer program.

13. A method of managing access to information using an ID information management system comprising at least one owner terminal and an ID control center, the method comprising:
storing the ID information in a predetermined format in the ID control center;
recording a second format used by the owner terminal; and
converting the ID information into the second format from the predetermined format when the information is accessed from the owner terminal.

14. A method according to claim 13, wherein all of the steps are executed by a computer program.

15. A method of managing access to information using an ID information management system comprising at least one owner terminal having an ID, an ID control center, and at least one provider terminal, the method comprising:
transmitting from the owner terminal to the provider terminal specification information specifying a product or a service to be provided;
transmitting from the provider terminal to the ID control center order information for providing the product or service based on the specification information; and
linking the order information and the ID in the ID control center,
wherein the ID control center uses the link to transmit information about the product or service ordered to the provider terminal in a future product or service request.

16. A method according to claim 15, wherein the order information includes information about the ID holder.

17. A method according to claim 16, wherein the linked order information, but not the specification information, is transmitted from the owner terminal to the provider terminal for the future product or service request.

18. A method according to claim 15, wherein all of the steps are executed by a computer program.

19. A method of managing access to information using an ID information management system comprising an ID control center, a first owner terminal used by a first ID holder, a second owner terminal used by a second ID holder having an ID, and at least one provider terminal, the method comprising:
transmitting from the first owner terminal to the provider terminal specification information specifying a product or a service to be provided to the second ID holder;
transmitting from the provider terminal to the ID control center order information for providing the product or service based on the specification information; and
linking the order information and the ID in the ID control center,
wherein the specification information contains information about the second ID holder, and wherein the ID control center uses the link to transmit information about the product or service ordered to the provider terminal in a future product or service request.

20. A method according to claim 19, wherein the specification information contains the ID.

21. A method according to claim 19, further comprising the steps of:
transmitting from the provider terminal to the ID control center a request for additional information about the second ID holder before transmitting to the ID control center the order information;
transmitting from the ID control center to the second owner terminal a request for the additional information; and
transmitting from the second owner terminal to the ID control center the requested additional information,
wherein the specification information does not contain sufficient information about the second ID holder for the product or service to be provided.

22. A method according to claim 19, wherein the linked order information, but not the specification information, is transmitted from the first owner terminal to the provider terminal for the future product or service request.

23. A method according to claim 19, wherein all of the steps are executed by a computer program.

24. An ID information management system for a combination of at least one owner terminal having an owner terminal ID, an ID control center, and at least one third-party terminal having a third-party terminal ID, the management system comprising:
a means for transmitting from the owner terminal to the ID control center an ID of an ID holder, at least one information item having a name and data, and a number of access points required for the third-party terminal to access the data;
a means for storing in the ID control center the ID of the ID holder, the information items, and the number of access points;
a means for transmitting the third-party terminal ID and a number of purchased points from the third-party terminal to the ID control center,
a means for storing the third-party terminal ID and the number of purchased points in the ID control center;
a means for transmitting an access request that includes the third-party terminal ID, the ID of the ID holder, and the name of the information item from the third-party terminal to the ID control center; and
a means for comparing the number of purchased points with the number of access points,
wherein if the number of purchased points is the greater than the number of access points, the data of the information item is transmitted to the third-party terminal and a value obtained by subtracting the number of access points from the number of purchased points is stored as the number of purchased points.

25. A system according to claim 24, wherein the number of access points is set to infinity for the information item to restrict access to the data of the information item.

26. An ID information management system for a combination of at least one owner terminal having an owner terminal ID, an ID control center, and at least one third-party terminal having a third-party terminal ID, the management system comprising:
a means for transmitting from the owner terminal to the ID control center an ID of an ID holder, at least one information item having a name and data, and an access-enabling condition for permitting the third-party terminal to access the data;
a means for storing in the ID control center the ID of the ID holder, the information item, and the access-enabling condition;
a means for transmitting from the third-party terminal to the ID control center an access request that includes the third-party terminal ID, the ID of the ID holder, the name of the information item, and an access request condition; and
a means for comparing the access request condition with the access-enabling condition,
wherein if these two conditions do not match, a dialog is established according to a predetermined talk script between the owner terminal and the third-party terminal to match the conditions.

27. A system according to claim 26, wherein the talk script is customizable.

28. An ID information management system for a combination of at least one owner terminal having an owner terminal ID, an ID control center, and at least one third-party terminal having a third-party terminal ID, the management system comprising:
a means for transmitting from the owner terminal to the ID control center an ID of an ID holder and at least one information item having a required name and data;
a means for storing in the ID control center the ID of the ID holder and the information items;
a means for transmitting an access request that includes the third-party terminal ID, the ID of the ID holder, and a requested name of the information item from the third-party terminal to the ID control center; and
a means for comparing the required name of the information item and the requested name of the information item,
wherein if the required name and the requested name match, the data is sent from the ID control center to the third-party terminal.

29. A system according to claim 28, wherein the required name of the information item is fixed.

30. A method according to claim 28, wherein the required name of the information item is variable.

31. An ID information management system for a combination of at least one owner terminal having an ID control center having an ID information and an access condition for accessing the ID information, and at least one third-party terminal having a third-party terminal ID, the management system comprising:
a means for compiling in the ID control center an access history information containing the third-party terminal IDs of the third-party terminals that have accessed the ID information; and
a means for modifying the access condition based on the access history information compiled.

32. An ID information management system for a combination of at least one owner terminal and an ID control center, the management system comprising:
a means for storing the ID information in a predetermined format in the ID control center;
a means for recording a second format used by the owner terminal; and
a means for converting the ID information from the predetermined format into the second format when the ID information is accessed from the owner terminal.

33. An ID information management system for a combination of at least one owner terminal having an owner terminal ID, an ID control center, and at least one provider terminal, the management system comprising:
a means for transmitting from the owner terminal to the provider terminal specification information for specifying a product or a service to be provided;
a means for transmitting from the provider terminal to the ID control center order information for providing the product or service based on the specification information; and
a means for linking the order information and the owner terminal ID in the ID control center,
wherein the link is used by the ID control center to transmit information about the product or service ordered to the provider terminal in a future product or service request.

34. A system according to claim 33, wherein the order information includes information about the ID holder.

35. An ID information management system for a combination of an ID control center, a first owner terminal used by a first ID holder, a second owner terminal used by a second ID holder having an ID, and at least one provider terminal, the management system comprising:
a means for transmitting from the first owner terminal to the provider terminal specification information for specifying a product or a service to be provided to the second ID holder;
a means for transmitting from the provider terminal to the ID control center order information for providing the product or service based on the specification information; and
a means for linking the order information and the owner terminal ID in the ID control center,
wherein the specification contains information about the second ID holder, and wherein the link is used by the ID control center to transmit information about the product or service ordered to the provider terminal in a future product or service request.

36. A system according to claim 35, wherein the specification information contains the ID.

37. A system according to claim 35, further comprising:
a means for transmitting from the provider terminal to the second owner terminal via the ID control center a request for additional information about the second ID holder; and
a means for transmitting from the second owner terminal to the ID control center the requested additional information,
wherein the specification information does not contain sufficient information about the second ID holder for the product or service to be provided.
